(19) United States
(12) Patent Application Publication
(10) Pub. No.: US 2019/0050705 A1
(43) Pub. Date: Feb. 14, 2019

(54) MAINTAINING NVDIMM TOPOLOGY TO PRESERVE PERSISTENT DATA

(71) Applicant: Intel Corporation, Santa Clara, CA (US)

(72) Inventors: Tiffany Kasanicky, Longmont, CO (US); Min Liu, Portland, OR (US)

(21) Appl. No.: 15/928,191

(22) Filed: Mar. 22, 2018

(51) Int. Cl. G06K 19/077; G06F 3/06

(52) U.S. Cl. CPC G06K 19/07758; G06F 3/0679; G06F 3/064; G06F 3/0604

(57) ABSTRACT

An embodiment of a semiconductor apparatus may include technology to determine installation location information for a memory component, determine tag information for a tag on the memory component, and store the installation location information in association with the tag. Other embodiments are disclosed and claimed.

### TECHNICAL FIELD

Embodiments generally relate to memory system. More particularly, embodiments relate to maintaining non-volatile dual-inline memory module (NVDIMM) topology to preserve persistent data.

### BACKGROUND

Computing devices may include a wide variety of memory arrangements. Large and/or complex data processing centers may include a large number of servers, each of which may include a large number of installed memory components such as NVDIMMs.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a semiconductor apparatus according to an embodiment;

FIGS. 3A to 3B are flowcharts of an example of a method of managing memory according to an embodiment;

FIG. 4 is a block diagram of another example of an electronic processing system according to an embodiment;

FIG. 5 is a block diagram of another example of a semiconductor apparatus according to an embodiment;

FIGS. 6A to 6B are flowcharts of another example of a method of managing memory according to an embodiment;

FIG. 7 is a block diagram of another example of an electronic processing system according to an embodiment;

FIG. 8 is an illustrative diagram of an example of a process flow for managing memory according to an embodiment;

FIG. 9 is an illustrative diagram of an example of a data structure for installation location-related information according to an embodiment; and

FIG. 10 is an illustrative diagram of another example of a process flow for managing memory according to an embodiment.

### DESCRIPTION OF EMBODIMENTS

Various embodiments described herein may include a memory component and/or an interface to a memory component. Such memory components may include volatile and/or nonvolatile memory. Nonvolatile memory may be a storage medium that does not require power to maintain the state of data stored by the medium. In one embodiment, the memory device may include a block addressable memory device, such as those based on NAND or NOR technologies. A memory device may also include future generation nonvolatile devices, such as a three dimensional crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product. In particular embodiments, a memory component with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at jedec.org).

Volatile memory may be a storage medium that requires power to maintain the state of data stored by the medium. Non-limiting examples of volatile memory may include various types of RAM, such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

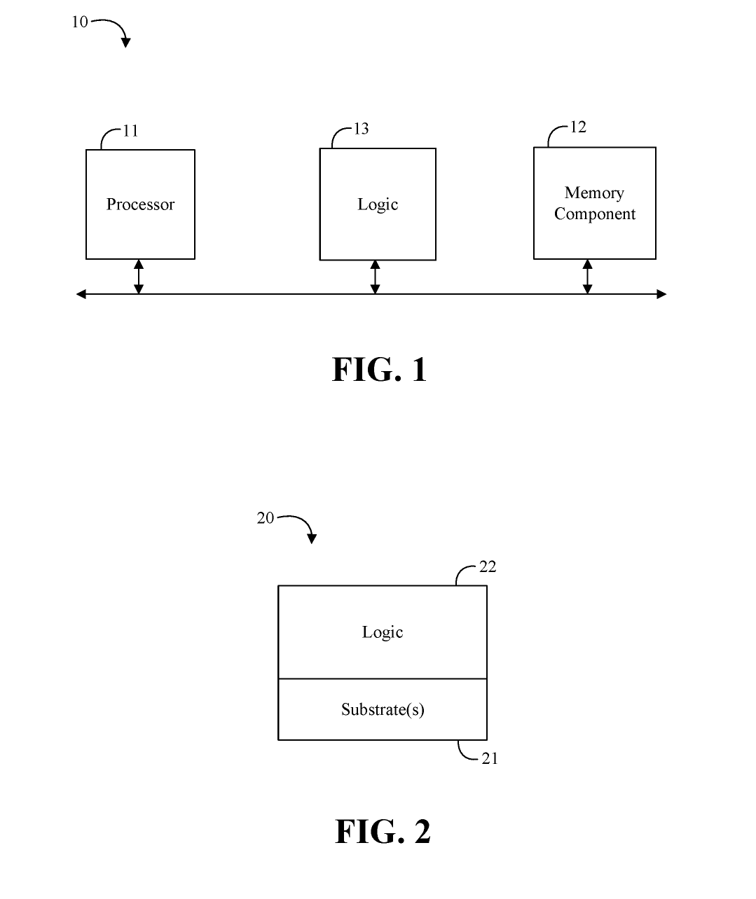

Turning now to FIG. 1, an embodiment of an electronic processing system 10 may include a processor 11, a memory component 12 communicatively coupled to the processor 11, and logic 13 communicatively coupled to the processor 11 to determine installation location information for the memory component 12, determine tag information for a tag on the memory component 12, and store the installation location information in association with the tag. In some embodiments, the logic 13 may be configured to store the installation location in a database in association with the tag information. In some embodiments, the tag may include a programmable radio frequency identification (RFID) tag physically affixed to the memory component 12. For example, the logic 13 may alternatively, or additionally, be configured to program the programmable RFID tag with the installation location information. In some embodiments, the installation location information may include one or more of system identification information, processor identification information, and memory controller identification information, and one or more of memory channel identification information and memory slot identification information. For example, the memory component 12 may include a non-volatile dual-inline memory module (NVDIMM). In some embodiments, the logic 13 may be located in, or co-located with, various components, including the processor 11 (e.g., on a same die).

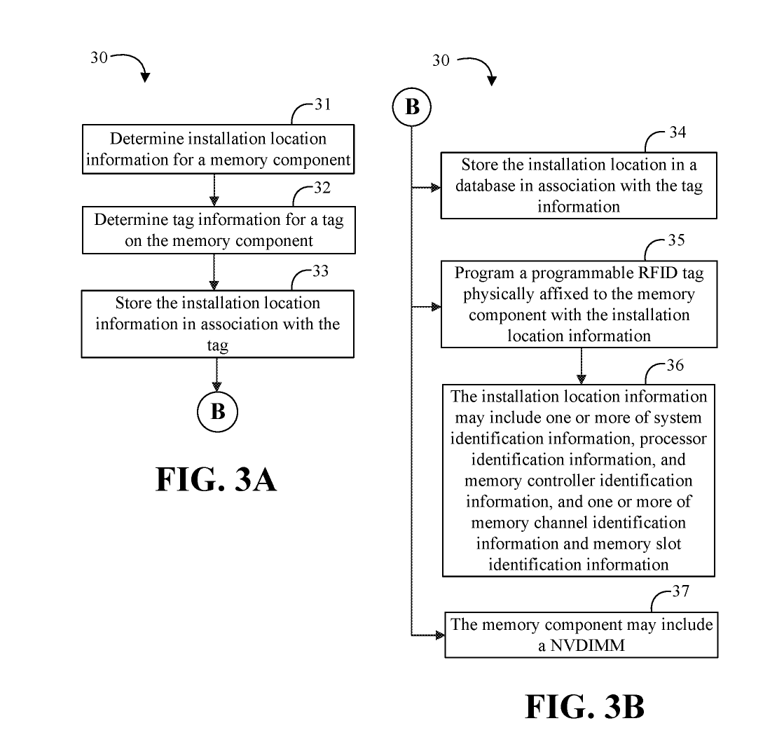

The system 10 may implement one or more aspects of the method 30 (FIGS. 3A to 3B), or any of the embodiments discussed herein. Embodiments of each of the above processor 11, memory component 12, logic 13, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the memory component 12, persistent storage media, or other system memory may store a set of instructions which when executed by the processor 11 cause the system 10 to implement one or more components, features, or aspects of the system 10 (e.g., the logic 13, determining installation location information for the memory component, determining tag information for a tag on the memory component, storing the installation location information in association with the tag, etc.).

Turning now to FIG. 2, an embodiment of a semiconductor apparatus 20 may include one or more substrates 21, and logic 22 coupled to the one or more substrates 21, wherein the logic 22 is at least partly implemented in one or more of configurable logic and fixed-functionality hardware logic. The logic 22 coupled to the one or more substrates 21 may be configured to determine installation location information for a memory component, determine tag information for a tag on the memory component, and store the installation location information in association with the tag. In some embodiments, the logic 22 may configured to store the installation location in a database in association with the tag information. In some embodiments, the logic 22 may alternatively, or additionally, be configured to program a programmable RFID tag physically affixed to the memory component with the installation location information. For example, the installation location information includes one or more of system identification information, processor identification information, and memory controller identification information, and one or more of memory channel identification information and memory slot identification information. In some embodiments, the memory component may include a NVDIMM. In some embodiments, the logic 22 coupled to the one or more substrates 21 may include transistor channel regions that are positioned within the one or more substrates 21.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

The apparatus 20 may implement one or more aspects of the method 30 (FIGS. 3A to 3B), or any of the embodiments discussed herein. In some embodiments, the illustrated apparatus 20 may include the one or more substrates 21 (e.g., silicon, sapphire, gallium arsenide) and the logic 22 (e.g., transistor array and other integrated circuit/IC components) coupled to the substrate(s) 21. The logic 22 may be implemented at least partly in configurable logic or fixed-functionality logic hardware. In one example, the logic 22 may include transistor channel regions that are positioned (e.g., embedded) within the substrate(s) 21. Thus, the interface between the logic 22 and the substrate(s) 21 may not be an abrupt junction. The logic 22 may also be considered to include an epitaxial layer that is grown on an initial wafer of the substrate(s) 21.

Turning now to FIGS. 3A to 3B, an embodiment of a method 30 of managing memory may include determining installation location information for a memory component at block 31, determining tag information for a tag on the memory component at block 32, and storing the installation location information in association with the tag at block 33. Some embodiments of the method 30 may include storing the installation location in a database in association with the tag information at block 34. Alternatively, or additionally, some embodiments of the method 30 may include programming a programmable RFID tag physically affixed to the memory component with the installation location information at block 35. For example, the installation location information may include one or more of system identification information, processor identification information, and memory controller identification information, and one or more of memory channel identification information and memory slot identification information at block 36. In some embodiments, the memory component may include a NVDIMM at block 37.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 30 may be implemented on a computer readable medium as described in connection with Examples 20 to 25 below. Embodiments or portions of the method 30 may be implemented in firmware, applications (e.g., through an application programming interface (API)), or driver software running on an operating system (OS).

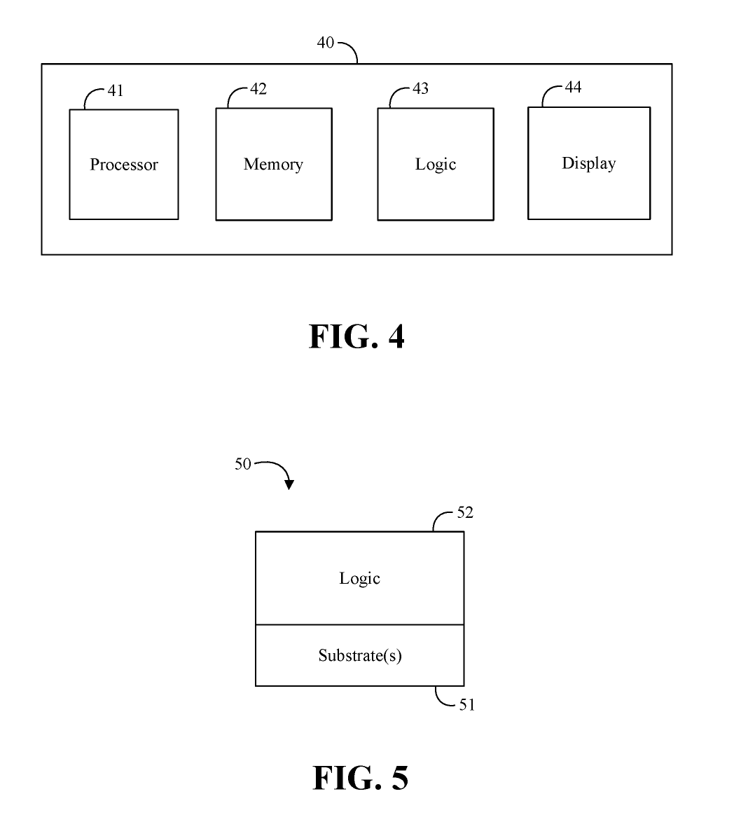

Turning now to FIG. 4, an embodiment of an electronic processing system 40 may include a processor 41, memory 42 communicatively coupled to the processor 41, and logic 43 communicatively coupled to the processor to electronically read tag information from a tag on an uninstalled memory component, and determine installation location information for the uninstalled memory component based on the tag information. The system 40 may further include a display 44 communicatively coupled to the processor 41 to display the installation location information. In some embodiments, the logic 43 may be configured to retrieve the installation location from a database based on the tag information. Alternatively, or additionally, the logic 43 may be further configured to electronically read RFID tag information from an RFID tag on the uninstalled memory component. For example, the RFID tag information may include the installation location information. In some embodiments, the RFID tag information may include one or more of system identification information, processor identification information, and memory controller identification information, and one or more of memory channel identification information and memory slot identification information. For example, the uninstalled memory component may include a NVDIMM. In some embodiments, the logic 43 may be located in, or co-located with, various components, including the processor 41 (e.g., on a same die).

For example, the system 40 may be housed in a portable, hand-held device such as an RFID reader. In some embodiments, the display 44 may simply display the information as read from the RFID tag. In some embodiments, the system may include technology to provide a graphical user interface (GUI) and the system 40 may process the tag information such that the GUI may graphically display the installation location based on the tag information.

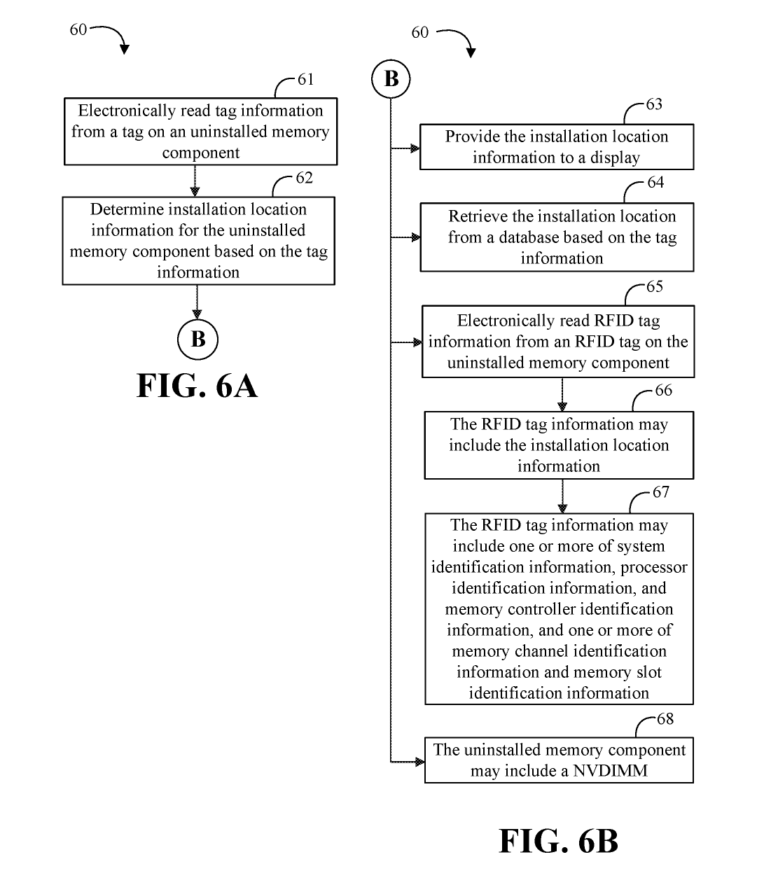

The system 40 may implement one or more aspects of the method 60 (FIGS. 6A to 6B), or any of the embodiments discussed herein. Embodiments of the processor 41, the memory 42, the logic 43, the display 44, and other components of the system 40, may be implemented in hardware, software, or any combination thereof. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

Turning now to FIG. 5, an embodiment of a semiconductor apparatus 50 may include one or more substrates 51, and logic 52 coupled to the one or more substrates 51, where the logic 52 is at least partly implemented in one or more of configurable logic and fixed-functionality hardware logic. The logic 52 coupled to the one or more substrates 51 may be configured to electronically read tag information from a tag on an uninstalled memory component, and determine installation location information for the uninstalled memory component based on the tag information. In some embodiments, the logic 52 may be further configured to provide the installation location information to a display. In some embodiments, the logic 52 may be configured to retrieve the installation location from a database based on the tag information. In some embodiments, the logic 52 may be configured to electronically read RFID tag information from an RFID tag on the uninstalled memory component. For example, the RFID tag information may include the installation location information. In some embodiments, the RFID tag information may include one or more of system identification information, processor identification information, and memory controller identification information, and one or more of memory channel identification information and memory slot identification information. For example, the uninstalled memory component may include a NVDIMM. In some embodiments, the logic 52 coupled to the one or more substrates 51 may include transistor channel regions that are positioned within the one or more substrates 51.

Embodiments of logic 52, and other components of the apparatus 50, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

The apparatus 50 may implement one or more aspects of the method 60 (FIGS. 6A to 6B), or any of the embodiments discussed herein. In some embodiments, the illustrated apparatus 50 may include the one or more substrates 51 (e.g., silicon, sapphire, gallium arsenide) and the logic 52 (e.g., transistor array and other integrated circuit/IC components) coupled to the substrate(s) 51. The logic 52 may be implemented at least partly in configurable logic or fixed-functionality logic hardware. In one example, the logic 52 may include transistor channel regions that are positioned (e.g., embedded) within the substrate(s) 51. Thus, the interface between the logic 52 and the substrate(s) 51 may not be an abrupt junction. The logic 52 may also be considered to include an epitaxial layer that is grown on an initial wafer of the substrate(s) 51.

Turning now to FIGS. 6A to 6B, an embodiment of a method 60 of managing memory may include electronically reading tag information from a tag on an uninstalled memory component at block 61, and determining installation location information for the uninstalled memory component based on the tag information at block 62. The method 60 may further include providing the installation location information to a display at block 63. Some embodiments of the method 60 may include retrieving the installation location from a database based on the tag information at block 64. Some embodiments of the method 60 may include electronically reading RFID tag information from an RFID tag on the uninstalled memory component at block 65. For example, the RFID tag information may include the installation location information at block 66. In some embodiments, the RFID tag information may include one or more of system identification information, processor identification information, and memory controller identification information, and one or more of memory channel identification information and memory slot identification information at block 67. For example, the uninstalled memory component may include a NVDIMM at block 68.

Embodiments of the method 60 may be implemented in a system, apparatus, computer, device, etc., for example, such as those described herein. More particularly, hardware implementations of the method 60 may include configurable logic such as, for example, PLAs, FPGAs, CPLDs, or in fixed-functionality logic hardware using circuit technology such as, for example, ASIC, CMOS, or TTL technology, or any combination thereof Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 60 may be implemented on a computer readable medium as described in connection with Examples 50 to 56 below. Embodiments or portions of the method 60 may be implemented in firmware, applications (e.g., through an application programming interface (API)), or driver software running on an operating system (OS).

Some embodiments may advantageously provide technology for maintaining a NVDIMM topology in order to preserve persistent data. In some systems, persistent memory from NVDIMMs may be interleaved together resulting in a contiguous range of memory that may be mapped in the system physical address space in which memory accesses from the CPU are sent to the NVDIMMs alternatively based on their address. Therefore, the physical topology of how the NVDIMMs are installed in a system relative to the CPU, memory controller and DIMM channel within the memory controller may be important in order to preserve the persistent data stored on the NVDIMMs. Because there may be a large number (e.g., dozens) of NVDIMMs per system, installing them in the correct topology even within a single system may be challenging. The challenge may be even greater when installing thousands of NVDIMMs in server racks (e.g., in a laboratory or datacenter). Some embodiments may advantageously maintain the NVDIMM topology to preserve the interleaved persistent data stored on the NVDIMMs. Some embodiments may utilize an RFID part installed on the NVDIMM and software/firmware to store the physical topology-related information of the NVDIMM in the RFID data when the NVDIMM is configured in the persistent memory arrangement. An installer may use an RFID reader to determine how to install a set of NVDIMMs in a system using the RFID part installed on each NVDIMM which stores the physical topology-related information.

Some other techniques may physically mark the NVDIMMs with their associated installation positions before uninstalling/moving the NVDIMMS. Physical markings, however, may be prone to error, may be lost over time, may be illegible or may become illegible over time, or may be confusing if another person is installing them. In some systems, the persistent memory configuration may also be stored in the non-volatile metadata. A problem during installation, however, is that retrieving the metadata requires the NVDIMMs to be installed and powered up. Some embodiments may provide a tag affixed on the NVDIMM such as a bar code, a quick response (QR) code, or other visually distinguished mark to identify the NVDIMM itself, separate from the NVDIMM's installation location-related information. The tag identification may be stored together with one or more of the NVDIMM identification and the NVDIMM's installation location-related information in a database. For example, the database may be stored on the system (e.g., on persistent storage media such as a hard disk drive (HDD), solid state drive (SSD), etc.), or may be stored or later transferred to removable media (e.g., such as a USB thumb drive, a SD memory card, etc.). In some embodiments, the database may be stored on or later transferred to a remotely accessible server and/or in the cloud. An appropriate reader (e.g., a bar code scanner, a QR scanner, etc.) may read the tag identification from an unpowered NVDIMM and look up the installation location-related information in the database. Providing the installation location information in a database may advantageously reduce the likelihood of such information getting misplaced and may also advantageously provide more consistent information to the installers.

Because some types of physical tags (e.g., bar codes, QR codes) may become loose or unaffixed over time, or may become unreadable over time, some embodiments may utilize a part which may be more securely affixed to the NVDIMM. For example, some embodiments may utilize an RFID part which may be soldered or otherwise electrically and/or mechanically affixed to the NVDIMM in a manner which makes it highly improbable that the RFID part may be inadvertently separated from the NVDIMM. Some embodiments may advantageously utilize an RFID part on each NVDIMM which may allow the information related to installing the NVDIMM to be retrieved at the point in time when a person is physically installing the NVDIMM (e.g., using an RFID reader to read the RFID part). In some embodiments, the RFID part may provide only an RFID tag identification and the installation location-related information may be stored in a separate database (e.g., as discussed above). An RFID reader may read the RFID tag identification from an unpowered NVDIMM and look up the installation location-related information in the database (e.g., from the cloud).

Some embodiments may utilize a programmable RFID tag which may store more than just the tag identification information. For example, some embodiments may store all of the needed installation location-related information on the programmable RFID tag, advantageously eliminating the need for an external database to determine the installation location-related information. Advantageously, some embodiments may reduce or minimize installation errors. For example, some embodiments may reduce the likelihood that a number of NVDIMMs may be installed incorrectly which may result in multiple power cycles to correct the installation and/or loss of persistent user data stored on the NVDIMMs.

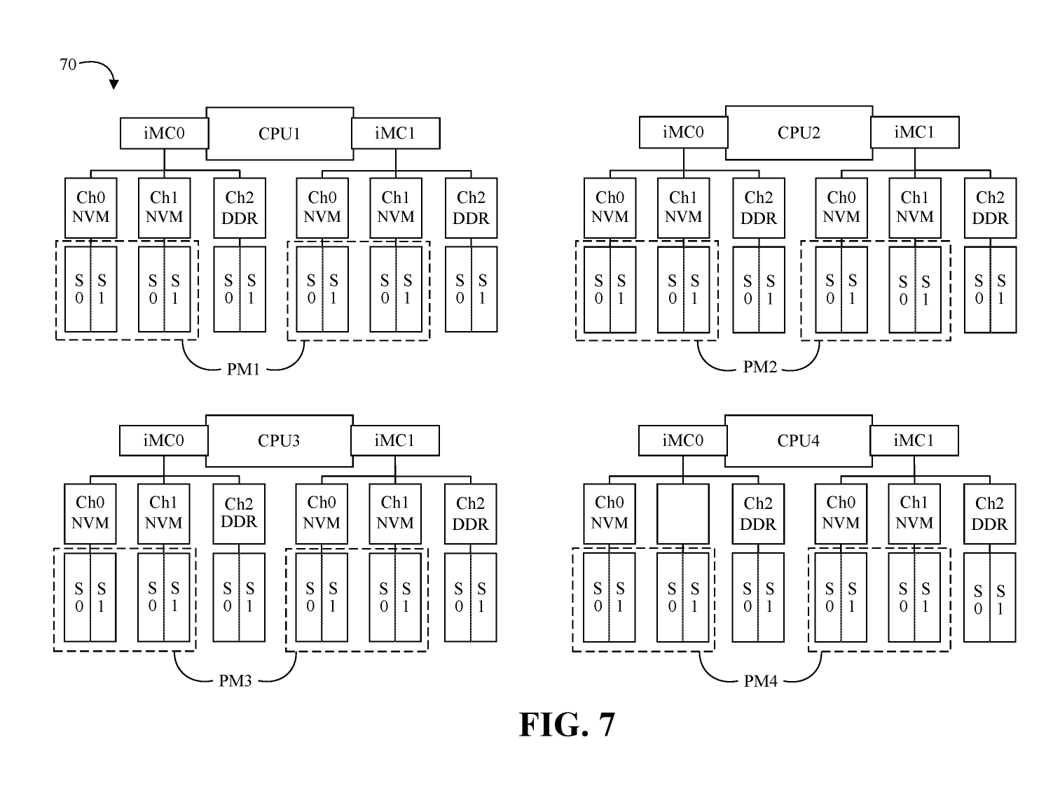

Turning now to FIG. 7, an embodiment of an electronic processing system 70 may include a multiple CPU socket system (e.g., four CPUs including CPU1, CPU2, CPU3, and CPU4), where each CPU has multiple memory controllers (e.g., two integrated memory controllers iMCO and iMC1), each memory controller has multiple channels (e.g., three channels CHO, CH1 and CH2), and each channel has multiple slots (e.g., two slots S0 and S1) to allow multiple DIMMs (e.g., DDR, non-volatile memory (NVM), etc.) with one DIMM installed in each slot. For NVDIMMs in the slots, persistent memory from the NVDIMMs may be interleaved within each CPU for better performance to create different persistent memory regions (e.g., four regions PM1, PM2, PM3, and PM4). These regions may represent persistent memory that is mapped in the system physical address space in which memory accesses from the CPU may be sent to the appropriate NVDIMM based on the address.

If the NVDIMMs are removed from the system 70 (e.g., to be re-installed later or to be moved to another system), the NVDIMMs must be installed back in the same topology relative to the CPU, memory controller, and channel in order for the persistent memory regions to be properly mapped into the system physical address space. If the NVDIMMs are not installed correctly, the persistent memory may not be properly mapped and the user data may be inaccessible. In general, moving dozens of NVDIMMs out of a system and putting them back in same topology may be prone to error. Some embodiments may advantageously solve this problem by installing an RFID part on the NVDIMMs (e.g., or utilizing an RFID part already installed on the NVDIMMs), and programming the physical topology of the NVDIMM into the RFID part when provisioning the persistent memory regions (e.g., using software and/or firmware to write the information to the RFID part).

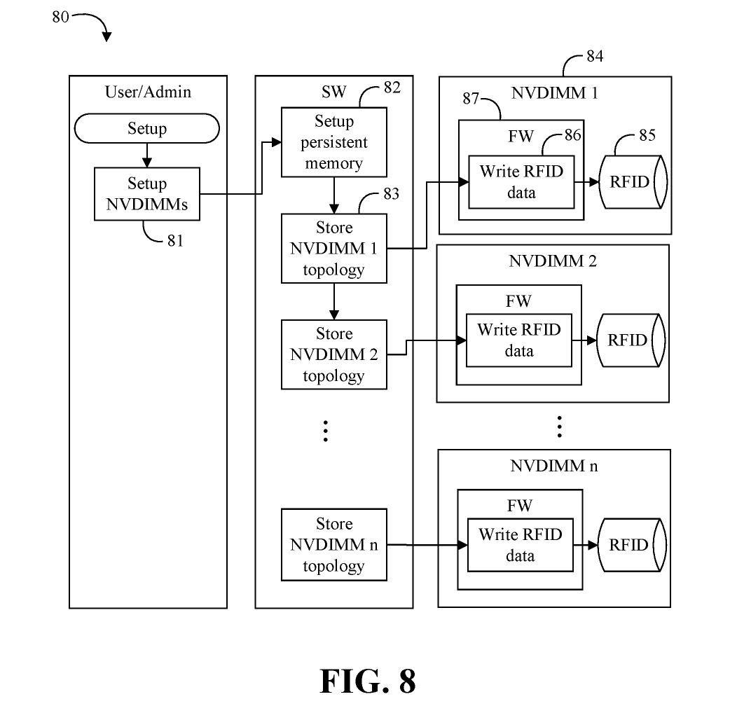

Turning now to FIG. 8, an embodiment of a process flow 80 for managing memory may include an initial setting up of one or more NVDIMMs (e.g., NVDIMM 1 through NVDIMM n, where n>1) at block 81 (e.g., by a user and/or administrator), when the NVDIMMs are first installed in a system (e.g., or during some subsequent reconfiguration of the NVDIMMs). For each of the NVDIMMs, software (SW) (e.g., BIOS, OS, configuration software, etc.) may setup the NVDIMM as persistent memory in the system at block 82, and then store the NVDIMM topology information at block 83. For example, each of the NVDIMMs 84 may include an RFID part 85 (e.g., a programmable RFID part capable of storing several fields). At block 86, the software may cause firmware (FW) 87 on the NVDIMMs to write RFID data to the RFID part (e.g., the RFID data may correspond to the NVDIMM topology information).

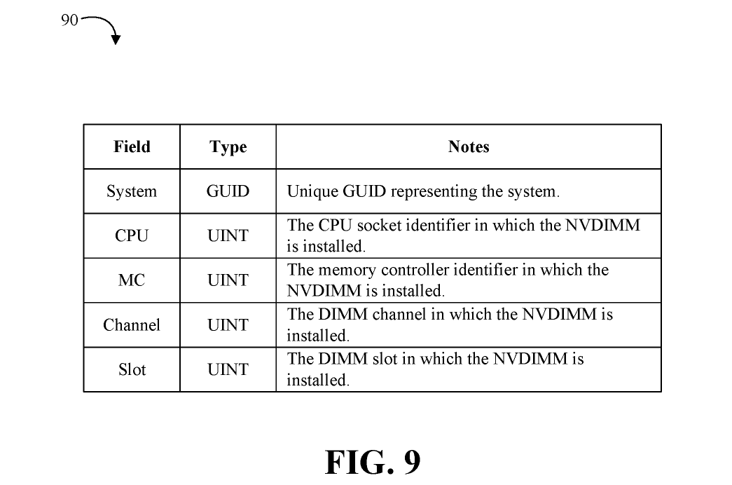

Turning now to FIG. 9, an embodiment of an illustrative data structure 90 for installation location-related information may include a system field, a CPU field, a memory controller (MC) field, a channel field, and a slot field. For example, the system field may contain a value having a type of a globally unique identifier (GUID) or a universally unique identifier (UUID) which may be a unique identifier for the system. Each of the CPU, MC, Channel, and Slot fields may contain a value having a type of an unsigned integer (UINT). The value of the CPU field may include a CPU socket identifier in which the NVDIMM is installed. The value of the MC field may include a memory controller identifier in which the NVDIMM is installed. The value of the Channel field may include a DIMM channel number in which the NVDIMM is installed. The value of the Slot field may include a DIMM slot number in which the NVDIMM is installed. For example, when a user configures the NVDIMMs with the system for use as persistent memory (e.g., using the BIOS, OS, or application software), the system may write the physical topology-related information of each NVDIMM onto the RFID part (e.g., via an NVDIMM firmware command to read/write the RFID part) into fields corresponding to the data structure 90. For example, the same software (BIOS, OS, firmware, etc.) utilized to configure the NVDIMM may be extended to program the RFID with the installation location-related information.

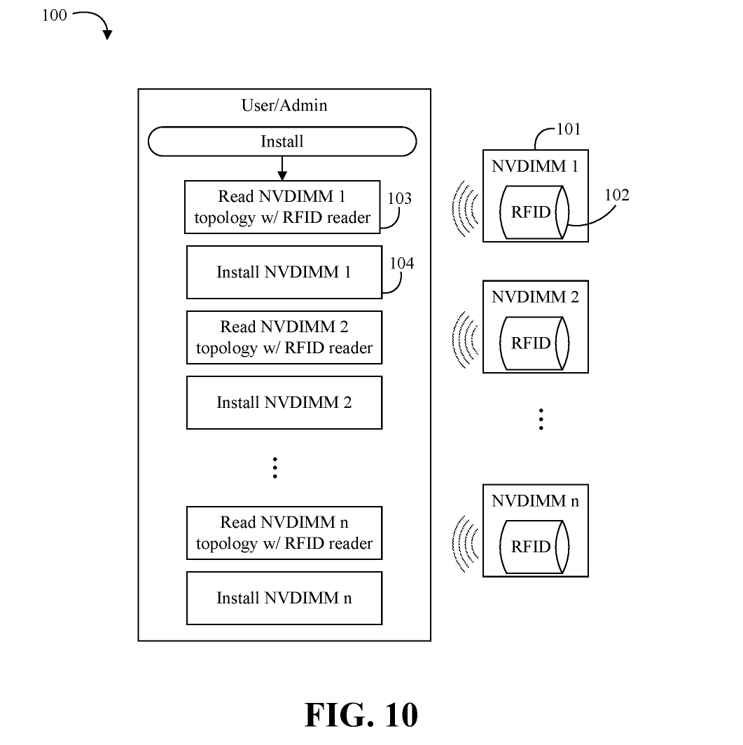

Turning now to FIG. 10, an embodiment of a process flow 100 of managing memory may include providing one or more NVDIMMs 101 (e.g., NVDIMM 1 through NVDIMM n, where n>1) with respective RFID parts 102 storing installation location-related information. If the NVDIMMs are removed/uninstalled, the subsequent installer may scan the RFID part of a NVDIMM with an RFID reader at block 103 to indicate the exact physical location to install that NVDIMM (e.g., in order to preserve the persistent memory data). Advantageously, the installation location-related information is self-contained on the NVDIMM itself and the RFID reader can extract the information without powering on the NVDIMM or the system. The installer may then install the NVDIMM at the indicated physical location at block 104, and repeat blocks 103 and 104 for each NVDIMM to be installed. After all the NVDIMMs are installed in accordance with their self-reported installation location-related information, all of the NVDIMMs will be installed in the correct topology for the pre-existing interleaved persistent memory regions to be properly mapped into the system physical address space making the user data stored on the NVDIMMs accessible to the system after the system is powered on.

### ADDITIONAL NOTES AND EXAMPLES

Example 1 may include an electronic processing system, comprising a processor, a memory component communicatively coupled to the processor, and logic communicatively coupled to the processor to determine installation location information for the memory component, determine tag information for a tag on the memory component, and store the installation location information in association with the tag.

Example 2 may include the system of Example 1, wherein the logic is further to store the installation location in a database in association with the tag information.

Example 3 may include the system of Example 1, wherein the tag comprises a programmable radio frequency identification tag physically affixed to the memory component.

Example 4 may include the system of Example 3, wherein the logic is further to program the programmable radio frequency identification tag with the installation location information.

Example 5 may include the system of Example 4, wherein the installation location information includes one or more of system identification information, processor identification information, and memory controller identification information, and one or more of memory channel identification information and memory slot identification information.

Example 6 may include the system of any of Examples 1 to 5, wherein the memory component comprises a non-volatile dual-inline memory module.

Example 7 may include a semiconductor apparatus, comprising one or more substrates, and logic coupled to the one or more substrates, wherein the logic is at least partly implemented in one or more of configurable logic and fixed-functionality hardware logic, the logic coupled to the one or more substrates to determine installation location information for a memory component, determine tag information for a tag on the memory component, and store the installation location information in association with the tag.

Example 8 may include the apparatus of Example 7, wherein the logic is further to store the installation location in a database in association with the tag information.

Example 9 may include the apparatus of Example 7, wherein the logic is further to program a programmable radio frequency identification tag physically affixed to the memory component with the installation location information.

Example 10 may include the apparatus of Example 9, wherein the installation location information includes one or more of system identification information, processor identification information, and memory controller identification information, and one or more of memory channel identification information and memory slot identification information.

Example 11 may include the apparatus of any of Examples 7 to 10, wherein the memory component comprises a non-volatile dual-inline memory module.

Example 12 may include the apparatus of any of Examples 7 to 10, wherein the logic coupled to the one or more substrates includes transistor channel regions that are positioned within the one or more substrates.

Example 13 may include a method of managing memory, comprising determining installation location information for a memory component, determining tag information for a tag on the memory component, and storing the installation location information in association with the tag.

Example 14 may include the method of Example 13, further comprising storing the installation location in a database in association with the tag information.

Example 15 may include the method of Example 13, further comprising programming a programmable radio frequency identification tag physically affixed to the memory component with the installation location information.

Example 16 may include the method of Example 15, wherein the installation location information includes one or more of system identification information, processor identification information, and memory controller identification information, and one or more of memory channel identification information and memory slot identification information.

Example 17 may include the method of any of Examples 13 to 16, wherein the memory component comprises a non-volatile dual-inline memory module.

Example 18 may include at least one computer readable medium, comprising a set of instructions, which when executed by a computing device, cause the computing device to determine installation location information for a memory component, determine tag information for a tag on the memory component, and store the installation location information in association with the tag.

Example 19 may include the at least one computer readable medium of Example 18, comprising a further set of instructions, which when executed by the computing device, cause the computing device to store the installation location in a database in association with the tag information.

Example 20 may include the at least one computer readable medium of Example 18, comprising a further set of instructions, which when executed by the computing device, cause the computing device to program a programmable radio frequency identification tag physically affixed to the memory component with the installation location information.

Example 21 may include the at least one computer readable medium of Example 15, wherein the installation location information includes one or more of system identification information, processor identification information, and memory controller identification information, and one or more of memory channel identification information and memory slot identification information.

Example 22 may include the at least one computer readable medium of any of Examples 18 to 21, wherein the memory component comprises a non-volatile dual-inline memory module.

Example 23 may include a memory management apparatus, comprising means for determining installation location information for a memory component, means for determining tag information for a tag on the memory component, and means for storing the installation location information in association with the tag.

Example 24 may include the apparatus of Example 23, further comprising means for storing the installation location in a database in association with the tag information.

Example 25 may include the apparatus of Example 23, further comprising means for programming a programmable RFID tag physically affixed to the memory component with the installation location information.

Example 26 may include the apparatus of Example 25, wherein the installation location information includes one or more of system identification information, processor identification information, and memory controller identification information, and one or more of memory channel identification information and memory slot identification information.

Example 27 may include the apparatus of any of Examples 23 to 26, wherein the memory component comprises a non-volatile dual-inline memory module.

Example 28 may include an electronic processing system, comprising a processor, memory communicatively coupled to the processor, and logic communicatively coupled to the processor to electronically read tag information from a tag on an uninstalled memory component, and determine installation location information for the uninstalled memory component based on the tag information.

Example 29 may include the system of Example 28, further comprising a display communicatively coupled to the processor to display the installation location information.

Example 30 may include the system of Example 28, wherein the logic is further to retrieve the installation location from a database based on the tag information.

Example 31 may include the system of Example 28, wherein the logic is further to electronically read RFID tag information from an RFID tag on the uninstalled memory component.

Example 32 may include the system of Example 31, wherein the RFID tag information includes the installation location information.

Example 33 may include the system of Example 32, wherein the RFID tag information includes one or more of system identification information, processor identification information, and memory controller identification information, and one or more of memory channel identification information and memory slot identification information.

Example 34 may include the system of any of Examples 28 to 33, wherein the uninstalled memory component comprises a non-volatile dual-inline memory module.

Example 35 may include a semiconductor apparatus, comprising one or more substrates, and logic coupled to the one or more substrates, wherein the logic is at least partly implemented in one or more of configurable logic and fixed-functionality hardware logic, the logic coupled to the one or more substrates to electronically read tag information from a tag on an uninstalled memory component, and determine installation location information for the uninstalled memory component based on the tag information.

Example 36 may include the apparatus of Example 35, wherein the logic is further to provide the installation location information to a display.

Example 37 may include the apparatus of Example 35, wherein the logic is further to retrieve the installation location from a database based on the tag information.

Example 38 may include the apparatus of Example 35, wherein the logic is further to electronically read RFID tag information from an RFID tag on the uninstalled memory component.

Example 39 may include the apparatus of Example 38, wherein the RFID tag information includes the installation location information.

Example 40 may include the apparatus of Example 39, wherein the RFID tag information includes one or more of system identification information, processor identification information, and memory controller identification information, and one or more of memory channel identification information and memory slot identification information.

Example 41 may include the apparatus of any of Examples 35 to 40, wherein the uninstalled memory component comprises a non-volatile dual-inline memory module.

Example 42 may include the apparatus of any of Examples 35 to 40, wherein the logic coupled to the one or more substrates includes transistor channel regions that are positioned within the one or more substrates.

Example 43 may include a method of managing memory comprising electronically reading tag information from a tag on an uninstalled memory component, and determining installation location information for the uninstalled memory component based on the tag information.

Example 44 may include the method of Example 43, further comprising providing the installation location information to a display.

Example 45 may include the method of Example 43, further comprising retrieving the installation location from a database based on the tag information.

Example 46 may include the method of Example 43, further comprising electronically reading RFID tag information from an RFID tag on the uninstalled memory component.

Example 47 may include the method of Example 46, wherein the RFID tag information includes the installation location information.

Example 48 may include the method of Example 47, wherein the RFID tag information includes one or more of system identification information, processor identification information, and memory controller identification information, and one or more of memory channel identification information and memory slot identification information.

Example 49 may include the method of any of Examples 43 to 48, wherein the uninstalled memory component comprises a non-volatile dual-inline memory module.

Example 50 may include at least one computer readable medium, comprising a set of instructions, which when executed by a computing device, cause the computing device to electronically read tag information from a tag on an uninstalled memory component, and determine installation location information for the uninstalled memory component based on the tag information.

Example 51 may include the at least one computer readable medium of Example 50, comprising a further set of instructions, which when executed by the computing device, cause the computing device to provide the installation location information to a display.

Example 52 may include the at least one computer readable medium of Example 50, comprising a further set of instructions, which when executed by the computing device, cause the computing device to retrieve the installation location from a database based on the tag information.

Example 53 may include the at least one computer readable medium of Example 50, comprising a further set of instructions, which when executed by the computing device, cause the computing device to electronically read RFID tag information from an RFID tag on the uninstalled memory component.

Example 54 may include the at least one computer readable medium of Example 53, wherein the RFID tag information includes the installation location information.

Example 55 may include the at least one computer readable medium of Example 54, wherein the RFID tag information includes one or more of system identification information, processor identification information, and memory controller identification information, and one or more of memory channel identification information and memory slot identification information.

Example 56 may include the at least one computer readable medium of any of Examples 50 to 55, wherein the uninstalled memory component comprises a non-volatile dual-inline memory module.

Example 57 may include a memory management apparatus, comprising means for electronically reading tag information from a tag on an uninstalled memory component, and means for determining installation location information for the uninstalled memory component based on the tag information.

Example 58 may include the apparatus of Example 57, further comprising means for providing the installation location information to a display.

Example 59 may include the apparatus of Example 57, further comprising means for retrieving the installation location from a database based on the tag information.

Example 60 may include the apparatus of Example 57, further comprising means for electronically reading RFID tag information from an RFID tag on the uninstalled memory component.

Example 61 may include the apparatus of Example 60, wherein the RFID tag information includes the installation location information.

Example 62 may include the apparatus of Example 61, wherein the RFID tag information includes one or more of system identification information, processor identification information, and memory controller identification information, and one or more of memory channel identification information and memory slot identification information.

Example 63 may include the apparatus of any of Examples 57 to 62, wherein the uninstalled memory component comprises a non-volatile dual-inline memory module.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic processing system, comprising:
a processor;
a memory component communicatively coupled to the processor; and
logic communicatively coupled to the processor to:
determine installation location information for the memory component,
determine tag information for a tag on the memory component, and
store the installation location information in association with the tag.

2. The system of claim 1, wherein the logic is further to:
store the installation location in a database in association with the tag information.

3. The system of claim 1, wherein the tag comprises a programmable radio frequency identification tag physically affixed to the memory component.

4. The system of claim 3, wherein the logic is further to:
program the programmable radio frequency identification tag with the installation location information.

5. The system of claim 4, wherein the installation location information includes one or more of system identification information, processor identification information, and memory controller identification information, and one or more of memory channel identification information and memory slot identification information.

6. The system of claim 1, wherein the memory component comprises a non-volatile dual-inline memory module.

7. A semiconductor apparatus, comprising:
one or more substrates; and
logic coupled to the one or more substrates, wherein the logic is at least partly implemented in one or more of configurable logic and fixed-functionality hardware logic, the logic coupled to the one or more substrates to:
determine installation location information for a memory component,
determine tag information for a tag on the memory component, and
store the installation location information in association with the tag.

8. The apparatus of claim 7, wherein the logic is further to:
store the installation location in a database in association with the tag information.

9. The apparatus of claim 7, wherein the logic is further to:
program a programmable radio frequency identification tag physically affixed to the memory component with the installation location information.

10. The apparatus of claim 9, wherein the installation location information includes one or more of system identification information, processor identification information, and memory controller identification information, and one or more of memory channel identification information and memory slot identification information.

11. The apparatus of claim 7, wherein the memory component comprises a non-volatile dual-inline memory module.

12. The apparatus of claim 7, wherein the logic coupled to the one or more substrates includes transistor channel regions that are positioned within the one or more substrates.

13. A method of managing memory, comprising:
determining installation location information for a memory component;
determining tag information for a tag on the memory component; and
storing the installation location information in association with the tag.

14. The method of claim 13, further comprising:
storing the installation location in a database in association with the tag information.

15. The method of claim 13, further comprising:
programming a programmable radio frequency identification tag physically affixed to the memory component with the installation location information.

16. The method of claim 15, wherein the installation location information includes one or more of system identification information, processor identification information, and memory controller identification information, and one or more of memory channel identification information and memory slot identification information.

17. The method of claim 13, wherein the memory component comprises a non-volatile dual-inline memory module.

18. At least one computer readable medium, comprising a set of instructions, which when executed by a computing device, cause the computing device to:
determine installation location information for a memory component;
determine tag information for a tag on the memory component; and
store the installation location information in association with the tag.

19. The at least one computer readable medium of claim 18, comprising a further set of instructions, which when executed by the computing device, cause the computing device to:
store the installation location in a database in association with the tag information.

20. The at least one computer readable medium of claim 18, comprising a further set of instructions, which when executed by the computing device, cause the computing device to:
program a programmable radio frequency identification tag physically affixed to the memory component with the installation location information.

21. The at least one computer readable medium of claim 15, wherein the installation location information includes one or more of system identification information, processor identification information, and memory controller identification information, and one or more of memory channel identification information and memory slot identification information.

22. The at least one computer readable medium of claim 18, wherein the memory component comprises a non-volatile dual-inline memory module.
